(19) United States
(12) Patent Application Publication
(10) Pub. No.: US 2008/0203799 A1
(43) Pub. Date: Aug. 28, 2008

(54) Seat Reclining apparatus for vehicle

(75) Inventor: Tomoaki Yamada, Kosai-shi (JP)

Correspondence Address: NATH & ASSOCIATES, 112 South West Street, Alexandria, VA, 22314, US

(73) Assignee: FUJI KIKO Co. Ltd, Kosai-shi (JP)

(21) Appl. No.: 12/068,160

(22) Filed: Feb. 4, 2008

(30) Foreign Application Priority Data
Feb. 28, 2007 (JP) 2007-049325

(51) Int. Cl. B60N 2/235

(52) U.S. Cl. 297/367

(57) ABSTRACT

A seat reclining apparatus includes: a disk-shaped base-side case; a disk-shaped arm-side case; a center shaft rotatably disposed in center part of the base-side case and center part of the arm-side case; a cam member fitted on the center shaft to rotate integrally with the center shaft; a lock tooth unit which cooperates with the cam member and engaged with a inner circumferential tooth portion formed on an inner periphery portion of the arm-side case; a lock spring; a protrusion protruding from an outer surface of the base-side case; and a recess at a position corresponding to the protrusion on an inner surface of the base-side case, wherein the lock spring is arranged in a space formed by the recess and a component accommodation space formed between the base-side case and arm-side case.

The present disclosure relates to subject matters contained in Japanese Patent Application No. 2007-049325 filed on Feb. 28, 2007, the disclosure of which is expressly incorporated herein by reference in its entirety.

### BACKGROUND OF THE INVENTION

1. Field of the Invention

The present invention relates to a seat reclining apparatus for a vehicle which adjusts a tilt position of a seatback relative to a seat cushion.

2. Description of the Related Art

As such a type of conventional seat reclining apparatus for a vehicle, there is a proposition disclosed in Japanese Patent Application Laid-open Publication No. 2002-345586.

As shown in FIG. 1, such a seat reclining apparatus 100 (located at both of left and right sides of a vehicle seat, the seat reclining apparatus located only one side of the vehicle seat are shown in the figures FIG. 1 to FIG. 3) for a vehicle includes a pair of base brackets 101 fixed to left and right ends of a seat cushion and a pair of arm brackets 102 fixed to left and right ends of a seatback. The left and right arm brackets 102 are supported by the respective left and right base brackets 101 so as to rotate around respective left and right center shafts 103. The left and right center shafts 103 are connected to each other through a connecting pipe 121. On an end of one of the center shafts 103, a reclining operation lever 120 is provided.

Around each center shaft 103, a spiral spring 104 is provided. One end of the spiral spring 104 is hooked to the base bracket 101 on the seat cushion, and the other end thereof is hooked to the arm bracket 102 on the seatback side. The seatback is urged by the spring force of the spiral spring 104 toward a forward tilt position. Between the left base bracket 101 and the left arm bracket 102 and between the right base bracket 101 and the right arm bracket 102 at each of the respective left and right ends of the vehicle seat, reclining lock mechanisms 110 are individually provided.

As shown in FIGS. 2 and 3, each of the reclining lock mechanisms 110 includes a base-side disk case 111, an arm-side disk case 112, a pair of lock tooth units 114 and 114, a cam plate 115, and a pair of lock springs 116 and 116. The base-side disk case 111 is fixed to the base bracket 101. The arm-side disk case 112 is fixed to the arm bracket 102 and includes an inner circumferential tooth portion 113 formed on the inner circumferential surface. The pair of lock tooth units 114 and 114 are accommodated in an outer peripheral part of a component accommodation space formed by both the disk cases 111 and 112. The cam plate 115 is accommodated in a central part of the component accommodation space formed by both the disk cases 111 and 112, and fitted on the center shaft 103 so as to rotate integrally with the center shaft 103. The lock springs 116 and 116 urge the cam plate 115 counterclockwise (toward a locked position) in FIG. 2. Each of the lock tooth units 114 and 114 is supported so as to swing around each of a fulcrum 114a provided for the base-side disk case 111. On outer circumferences of the lock tooth units 114 and 114, outer circumferential tooth portions 117 and 117 are individually formed. In a part of the base-side disk case 111 on the component accommodation space side, a plurality of tooth receiving portions 118 are provided integrally with the base-side disk case 111. The tooth receiving portions 118 guide the swinging movement of the lock tooth units 114 and 114, and receive external force from the lock tooth units 114 and 114.

In the aforementioned structure, the outer circumferential tooth portions 117 and 117 of the lock tooth units 114 and 114 are engaged with the inner circumferential tooth portion 113 of the arm-side disk case 112 by spring force of the lock springs 116 and 116 in the reclining lock mechanism 110, and the seatback is thus locked to the seat cushion.

In this state, a user operates the reclining operation lever 120 to rotate the center shaft 103 clockwise in FIG. 2 against the spring force of the lock springs 116 and 116. The cam plate 115 then presses the lock tooth units 114 and 114. The lock tooth units 114 and 114 are individually rotated counterclockwise of FIG. 2 around the respective fulcrums 114a and 114a to be displaced to positions where the outer circumferential tooth portions 117 and 117 of the lock tooth units 114 and 114 are disengaged from the inner circumferential tooth portion 113. The reclining lock mechanism 110 is thus unlocked.

When the reclining lock mechanism 110 is unlocked, the seatback is urged by the spring force of the spiral spring 104 to move to the forward tilt position. The user then moves the seatback to a desired tilt position against or with the spring force of the spiral spring 104. After setting the seatback to the desired tilt position, the user releases the reclining operation lever 120. The cam plate 115 then rotates toward the locked position by the spring force of the lock springs 116 and 116. In this rotating process, the cam plate 115 presses the lock tooth units 114 and 114, and rotates the same clockwise in FIG. 2 around, the respective fulcrums 114a and 114a to be displaced to the position where the outer peripheral tooth portions 117 and 117 of the lock tooth units 114 and 114 are engaged with the inner circumferential tooth portion 113. The reclining lock mechanism 110 is thus locked. The reclining position of the seatback can be freely adjusted in such a manner.

Meanwhile, the seat reclining apparatus 100 is required to increase in load bearing capacity. In the aforementioned conventional art, to obtain adequate force urging the lock tooth units 114 and 114 in the locked direction, the number of turns or plate thickness of each lock spring 116 is increased since space in the thickness direction is limited. Accordingly, the size of the plurality of tooth receiving portions 118, which guide the lock tooth units 114, is limited. The seat reclining apparatus 100 for a vehicle is therefore prevented from increasing in strength, and decreasing in size.

### SUMMARY OF THE INVENTION

The present invention has been achieved with such points in mind.

It therefore is an object of the present invention to provide a seat reclining apparatus for a vehicle increasing in load bearing capacity without increasing in size.

To achieve the object, according to a first aspect of the present invention, there is provided a seat reclining apparatus for a vehicle, including: a disk-shaped base-side case fixed to a first one of a bracket on a seat cushion side and a bracket on a seatback side; a disk-shaped arm-side case fixed to a second one of the brackets and rotatably assembled to the base-side case, the arm-side case including an inner circumferential tooth portion on a periphery of a circular recess concentrically formed; a component accommodation space formed between the base-side case and arm-side case; a center shaft rotatably disposed in center part of the base-side case and center part of the arm-side case while penetrating the component accommodation space; a cam member fitted on the center shaft to rotate integrally with the center shaft in the component accommodation space and moved by the rotation of the center shaft between a locked position and an unlocked position; a lock tooth unit which is arranged radially outside of the cam member in the component accommodation space and cooperates with the cam member, the lock tooth unit being located at an engaged position where the lock tooth unit is engaged with the inner circumferential tooth portion when the cam member is at the locked position and being located at a disengaged position where the lock tooth unit is separated from the inner circumferential tooth portion when the cam member is at the unlocked position; a lock spring which is arranged radially outside of the cam member in the component accommodation space, and urges the cam member toward the locked position; a protrusion protruding from an outer surface of the base-side case; and a recess at a position corresponding to the protrusion on an inner surface of the base-side case. In this vehicle seat reclining apparatus, the lock spring is arranged in a space formed by the recess and the component accommodation space.

A second aspect of the present invention is the vehicle seat reclining apparatus of the first aspect, in which the protrusion is fitted into a hole provided for the first bracket, and fixed by welding the fitted protrusion and an edge of the hole of the first bracket.

According to the first aspect of the present invention, the spring accommodation space can be configured to increase in size without an increase in width of the vehicle seat reclining apparatus, so that the spring accommodation space can accommodate the lock spring with a larger plate width than that of a conventional seat reclining apparatus. Accordingly, even if spring force stronger than that of the conventional art is required, the number of turns and plate thickness of the lock spring can be equal to those of the conventional seat reclining apparatus. It is therefore possible to prevent reduction in strength due to an increase in size of the lock spring, and further prevent an increase in size of the apparatus. Moreover, the lock spring can secure spring force equal to that of the conventional seat reclining apparatus with a smaller number of turns or a smaller plate thickness, and can be therefore accommodated in smaller area. The tooth receiving portion can be configured to be larger accordingly, thus increasing the load bearing capacity without an increase in size.

According to the second aspect of the present invention, the holes provided for one of the bracket on the seat cushion side and the bracket on the backseat side are fitted and fixed to the protrusions to increase the area of the joint, thus increasing attachment strength.

### BRIEF DESCRIPTION OF THE ACCOMPANYING DRAWINGS

The above and further objects and novel features of the present invention will more fully appear from the following detailed description when the same is read in conjunction with the accompanying drawings, in which:

FIG. 1 is a partial cross-sectional view of a seat reclining apparatus of a conventional example;

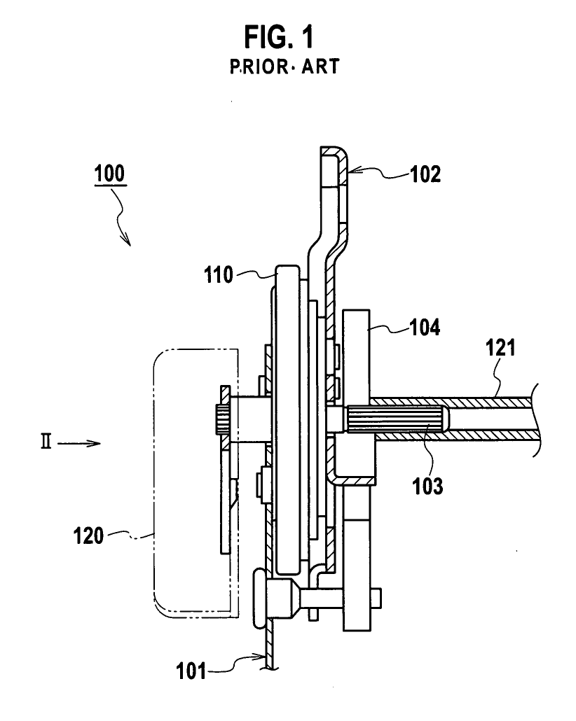

FIG. 2 is a front view of a reclining lock mechanism of the conventional example in an arrow direction II of FIG. 1;

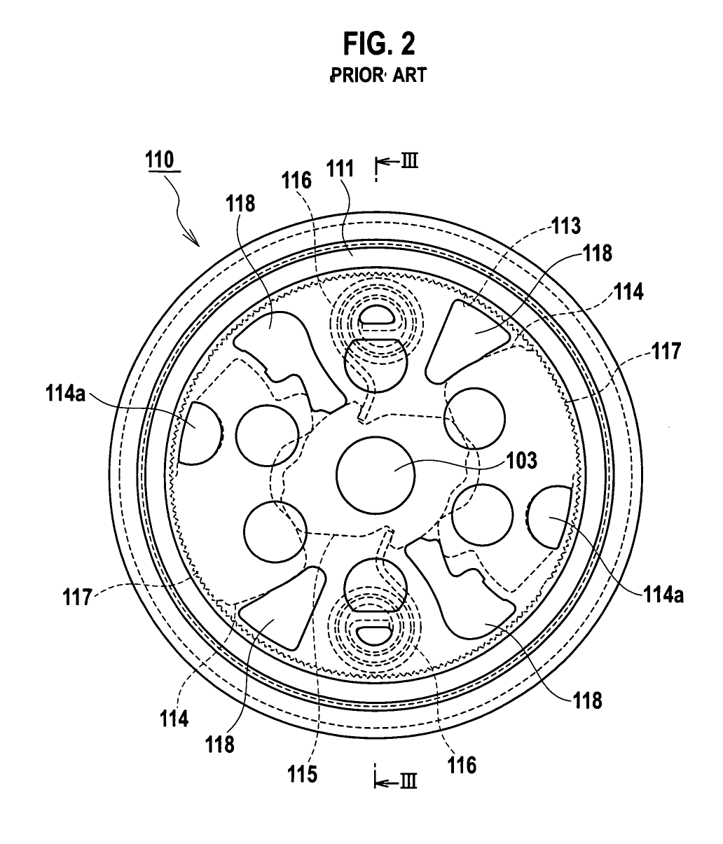

FIG. 3 is a cross-sectional view of the conventional example taken along line III-III of FIG. 2;

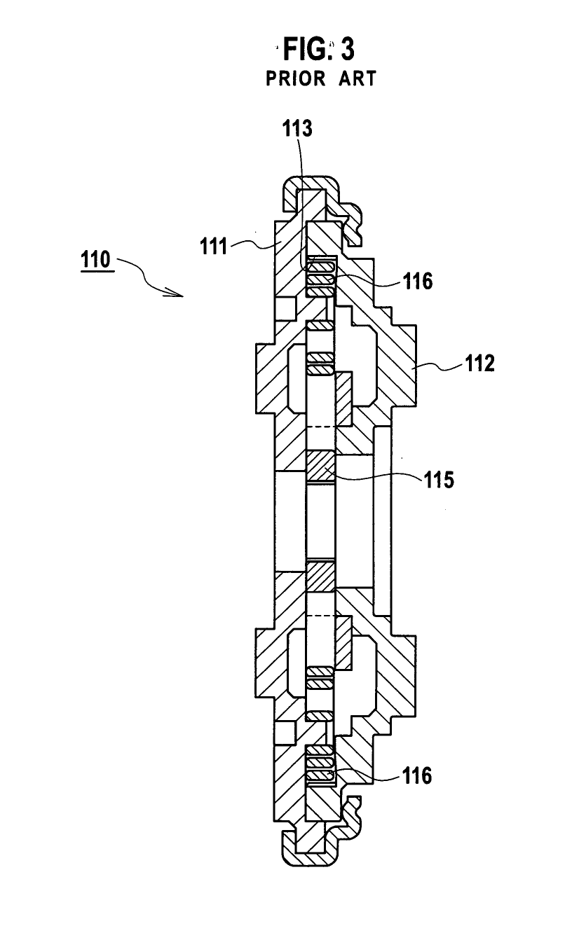

FIG. 4 is a partial cross-sectional view of a seat reclining apparatus of a first embodiment of the present invention;

FIG. 5 is a front view of a reclining lock mechanism of the first embodiment of the present invention in an arrow direction V of FIG. 4;

FIG. 6 is a cross-sectional view of the first embodiment of the present invention taken along line VI-VI of FIG. 4;

FIG. 7 is a cross-sectional view of the first embodiment of the present invention taken along line VII-VII of FIG. 5;

FIG. 8 is a front view of a reclining lock mechanism of a second embodiment of the present invention;

FIG. 9 is a cross-sectional view of the second embodiment of the present invention taken along line IX-IX of FIG. 8; and

FIG. 10 is a front view of the reclining lock mechanism of the second embodiment where hatching indicates areas by which the reclining lock mechanism of the second embodiment is larger than that of the first embodiment.

### DETAILED DESCRIPTION OF THE EMBODIMENTS

There will be detailed below the preferred embodiments of the present invention with reference to the accompanying drawings. Like members are designated by like reference characters.

### First Embodiment

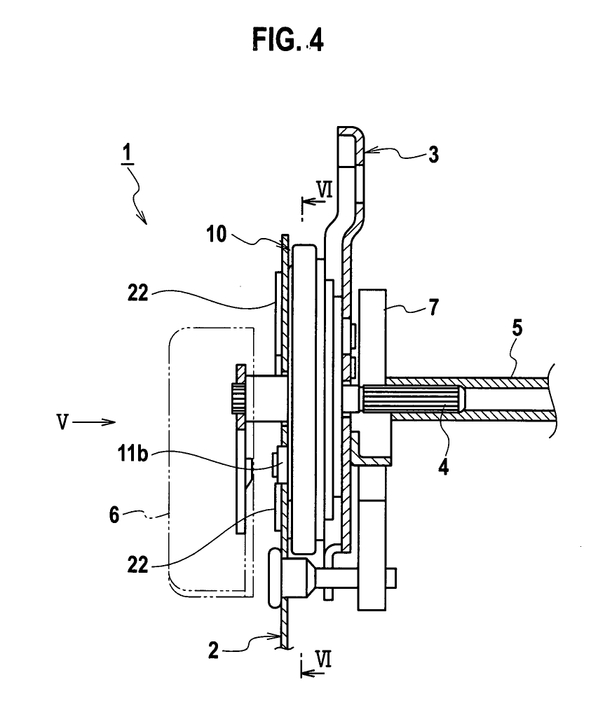

FIGS. 4 to 7 show a first embodiment of the present invention. As shown in FIG. 4, a seat reclining apparatus 1 for a vehicle (which is located at both of left and right sides of a vehicle seat, hereinbelow, the seat reclining apparatus located only one side of the left and right sides of the vehicle seat are shown in the figures FIG. 4 to FIG. 10) includes a left and right base brackets 2 fixed to left and right ends of a seat cushion, and a left and right arm brackets 3 fixed to left and right ends of a seatback of the vehicle seat. Each of the arm brackets 3 is respectively supported by each of the base brackets 2 so as to rotate around each one of left and right center shafts 4 as shown in FIG. 4. The left and right center shafts 4 are connected to each other through a connecting pipe 5. For one end of the center shafts 4, a reclining operation lever 6 is provided.

Around each of the center shaft 4 of the each left and right seat reclining apparatus 1, a spiral spring 7 is respectively disposed. One end of the spiral spring 7 is hooked to the base bracket 2 on the seat cushion side, and the other end thereof is hooked to the arm bracket 3 on the seatback side. The seatback is urged to a forward tilt position by spring force of the spiral spring 7. Between the respective base bracket 2 and the respective arm bracket 3 of the each left and right seat reclining apparatus 1, a reclining lock mechanism 10 is individually disposed. Since the paired reclining lock mechanisms 10 of the each left and right seat reclining apparatus 1 have the same constitution and same functions and same results, the following description is thus given for the constitution of only one end of the reclining lock mechanisms 10 of the each left and right seat reclining apparatus 1.

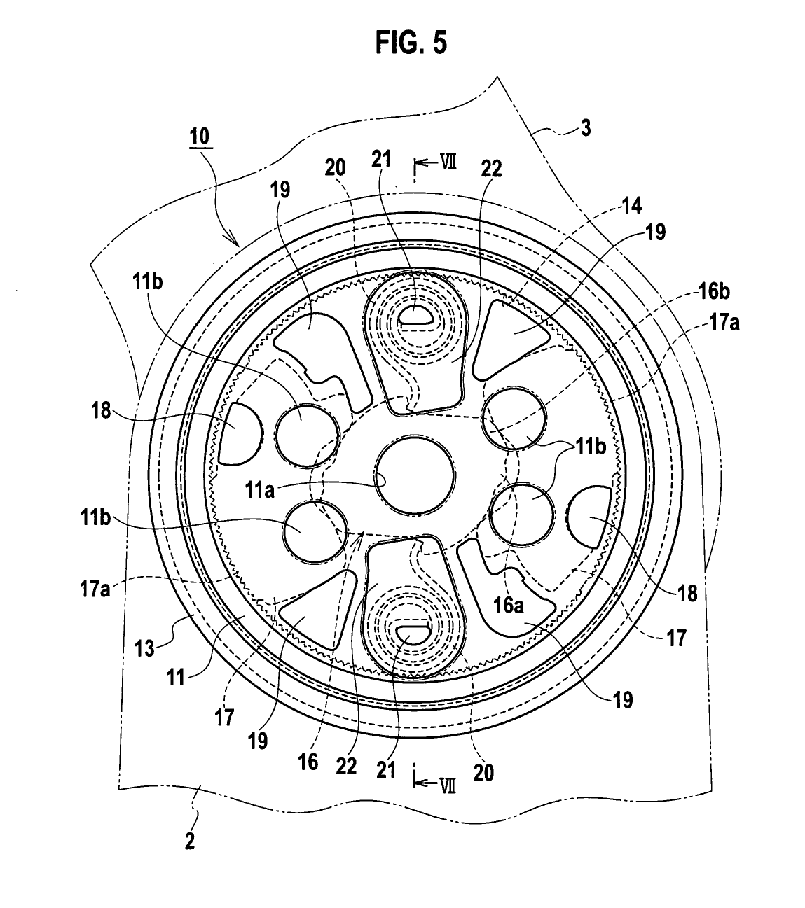

As shown in FIGS. 5 to 7, the reclining lock mechanism 10 includes a disk-shaped base-side case 11 fixed to the base bracket 2, and a disk-shaped arm-side case 12 rotatably supported by the base-side case 11. The outer circumferential surface of the arm-side case 12 slides on the inner circumferential surface of a circular recess formed in the base-side case 11. The arm-side case 12 includes an inner circumferential tooth portion 14 on the periphery of a circular recess concentrically formed. Both the cases 11 and 12 are assembled to each other by a ring-shaped holder 13 crimped on the outer peripheries of the cases 11 and 12 so as not to be displaced in the axial direction. The inner circumferential tooth portion 14 is integrally provided for circumferentially all around the inner circumferential surface of the circular recess of the arm-side case 12. Structures to fix the base-side and arm-side cases 11 and 12 to the respective brackets 2 and 3 are described later.

Between both the assembled cases 11 and 12, a component accommodation space 15 is formed in the circular recess of the arm-side case 12. The center shaft 4 is rotatably disposed in holes formed in central parts of the cases 11 and 12 and penetrated through the component accommodation space 15.

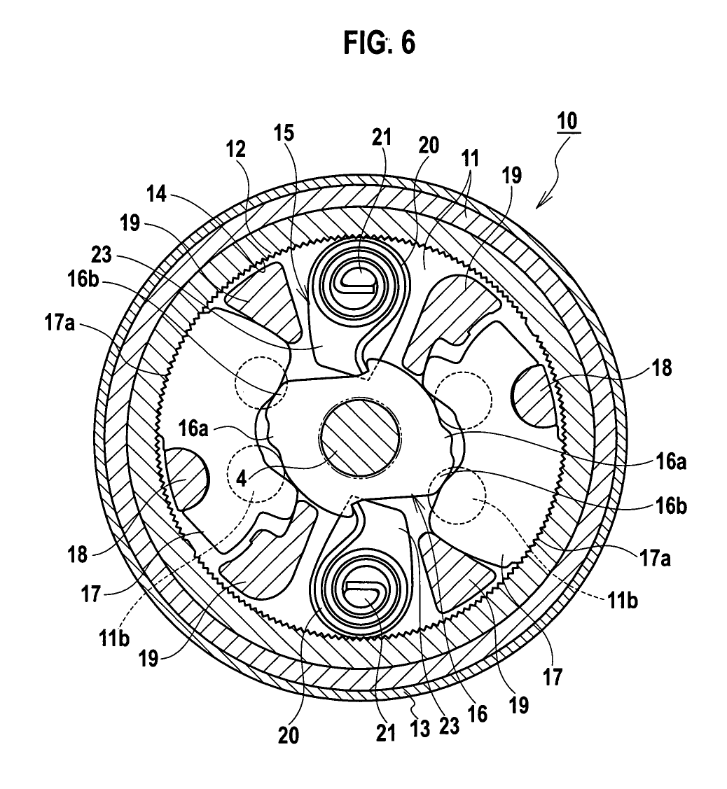

In a central part of the component accommodation space 15, a cam member 16 is accommodated. The center shaft 4 is penetrated through the cam member 16. The cam member 16 is fixed on the outer periphery of the center shaft 4, and rotated between a locked position (FIGS. 5 and 6) and an unlocked position by rotation of the center shaft 4. In a space of the component accommodation space 15 radially outside of the cam member 16, a pair of lock tooth units 17 and 17 is accommodated circumferentially 180 degrees apart from each other.

The respective lock tooth units 17 and 17 are supported so as to swing around tooth supporting portions 18, which are integrally protruded from the base-side case 11 into the component accommodation space 15. Each lock tooth unit 17 includes an outer circumferential tooth portion 17a, and is displaced in cooperation with the cam member 16 between an engaged position (positions in FIGS. 5 and 6) and a disengaged position. The engaged position is where the outer circumferential tooth portion 17a is engaged with the inner circumferential tooth portion 14, whereas the disengaged position is where the outer circumferential tooth portion 17a is disengaged from the inner circumferential tooth portion 14. In the vicinities of movement paths of both ends of each lock tooth unit 17, a pair of tooth receiving portions 19 are individually protruded integrally from the base-side case 11 into the component accommodation space 15. The pair of tooth receiving portions 19 guides the lock tooth unit 17 moving between the engaged position and disengaged position, and receives through the lock tooth unit 17 force acting on the arm-side case 12. In other words, the tooth receiving portions 19 stop the respective lock tooth unit 17 moving in the circumferential direction together with the arm-side case 12, in order to prevent the arm-side case 12 from rotating relative to the base-side case 11, thus keeping the locked state.

In a space of the component accommodation space 15 radially outside of the cam member 16, a pair of lock springs 20 are individually accommodated circumferentially between the tooth receiving portions 19. Each of the lock springs 20 is a spiral spring whose spiral center (an inner end) is supported on a spring supporting protrusion 21, which is integrally protruded from the base-side case 11. A top arm of each lock spring 20 (an outer end) is hooked to the cam member 16. The cam member 16 is urged clockwise (in FIG. 6) toward the locked position by spring force of the paired lock springs 20. When the cam member 16 is at the locked position, the spring force of the lock springs 20 acts on the paired lock tooth units 17 through the cam member 16, and the outer circumferential tooth portions 17a are therefore engaged with the inner circumferential tooth portion 14.

On the outer surface of the base-side case 11 opposite to the component accommodation space, circular attachment protrusions 11b are arranged circumferentially at intervals around a shaft hole 11a. On the outer surface of the base-side case 11, a pair of protrusions 22 are formed so as to protrude from the outer surface of the base-side case 11. The pair of protrusions 22 are larger than the profile of the lock springs 20. The pair of protrusions 22 are arranged in the circumferential direction together with the attachment protrusions 11b.

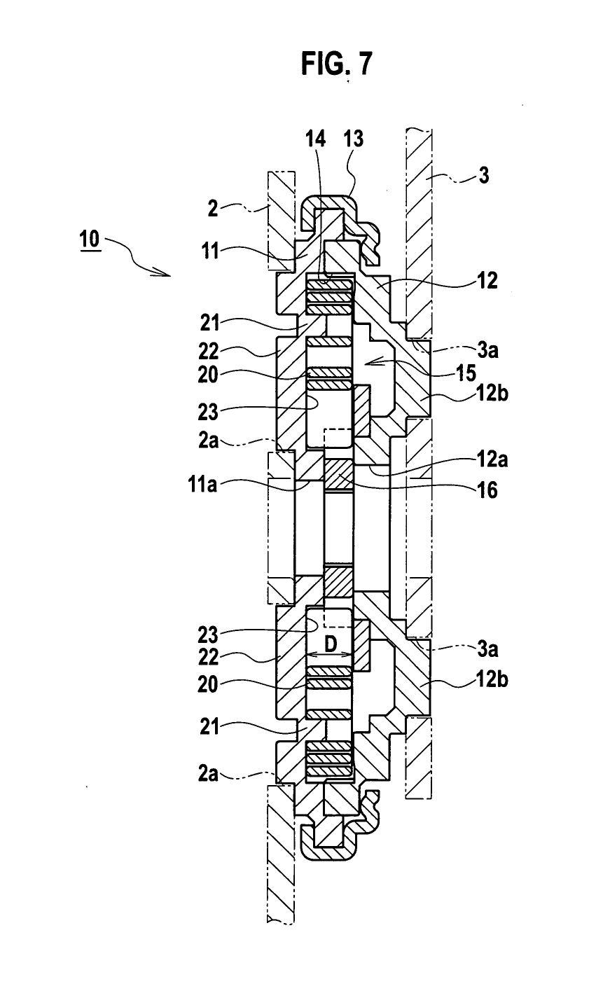

On an inner surface of the base-side case 11, as shown in detail in FIG. 7, recesses 23 are formed at positions corresponding to the protrusions 22. In other words, the attachment protrusions 11b and protrusions 22 are formed by pressing the base-side case 11 for half blanking, and the recesses having substantially the same shapes as those of the protrusions are formed on the opposite surface. Because of these recesses 23, the spring accommodation spaces of the component accommodation space 15 are made wider (width D) than the other space. The width D of the spring accommodation spaces of the component accommodation space 15 is set larger than the other space, whereas the dimensions of the protrusion of the base-side case 11 toward the outer surface side are maintained equal to those of the conventional seat reclining apparatus. Accordingly, each lock spring 20 has a number of turns and plate thickness equal to those of the conventional seat reclining apparatus, and has a larger plate width. The spring force of the lock springs 20 is therefore larger than that of the conventional seat reclining apparatus.

The pair of protrusions 22 and four attachment protrusions 11b are respectively inserted into attachment holes 2a of the base brackets 2, and welded to fix the base-side case 11 to the base brackets 2. In other words, the pair of protrusions 22 is also used as protruding attachments to the base bracket 2.

On the outer surface of the arm-side case 12, attachment protrusions 12b are arranged in the circumferential direction at intervals around a shaft hole 12a. The attachment protrusions 12b are inserted into attachment holes 3a of the arm brackets 3, and welded to fix the arm-side case 12 to the arm bracket 3.

In the aforementioned constitution, in the reclining lock mechanism 10, the outer circumferential tooth portions 17a of the lock tooth units 17 are engaged with the inner circumferential tooth portion 14 of the arm-side case 12 by the spring force of the lock springs 20. The seatback is thus locked to the seat cushion.

In this state, the user operates the reclining operation lever 6 to rotate the center shaft 4 counterclockwise in FIG. 6 against the spring force of the lock springs 20. Two first pressing portions 16a of the cam member 16 press respective unlocking surfaces of the pair of lock tooth units 17. The lock tooth units 17 then rotate around the tooth supporting portions 18 counterclockwise in FIG. 6 to be displaced to a disengaged position, in which the outer circumferential tooth portions 17a of the lock tooth units 17 are disengaged from the inner circumferential tooth portion 14. The reclining lock mechanism 10 is thus unlocked.

When the reclining lock mechanism 10 is unlocked, the seatback is urged to the forward tilt position by the spring force of the spiral spring 7. The user moves the seatback to the desired tilt position, against or with the spring force of the spiral spring 7. After the seatback is positioned at the desired tilt position, the user releases the reclining operation lever 6. The cam member 16 then rotates toward the locked position by the spring force of the pair of lock springs 20. In such a rotation process, two second pressing portions 16b of the cam plate 16 press respective locking surfaces of the pair of lock tooth units 17. The lock tooth units 17 then rotate counterclockwise in FIG. 6 around the respective tooth supporting portion 18 to be displaced to the respective engaged positions, in which the outer circumferential tooth portions 17a are engaged with the inner circumferential tooth portion 14. The reclining lock mechanism 10 is locked again. The tilt position of the seatback can be freely adjusted in such a manner.

In the aforementioned seat reclining apparatus 1 for a vehicle, the protrusions 22 are protruded on the outer surface of the base-side case 11, and the recesses 23 are formed on the inner surface of the base-side case 11 at the positions corresponding to the protrusions 22. The lock springs 20 are arranged in the spring accommodation spaces formed by these recesses 23 and component accommodation space 15, and the protrusions 22 are also used as the protruding attachments. Accordingly, the spring accommodation spaces can be configured to increase in size without an increase in width of the seat reclining apparatus 1 for a vehicle in the axial direction, so that the spring accommodation spaces can accommodate the lock springs 20 wider than those of the conventional seat reclining apparatus. Accordingly, even if spring force stronger than that of the conventional art is required, the number of turns and plate thickness of the lock springs 20 can be made equal to those of the conventional seat reclining apparatus. It is therefore possible to prevent reduction in size of the tooth receiving portions 19, and an increase in size of the base-side case 11 due to an increase in diameter of the lock springs, thus preventing an increase in size of the seat reclining apparatus for a vehicle.

In the first embodiment, the two protrusions 22 are provided at the opposed positions at an angle of 180 degrees (positions at equal intervals in the circumferential direction) around the center shaft 4. Accordingly, rotation moment can be equally divided, and applied to the two protrusions 22 in a balanced manner. It should be noted that, in this first embodiment, although the protrusions 22 are provided at the opposed two positions at an angle of 180 degrees, it is obvious that three or more protrusions may be provided at equal intervals in the circumferential direction.

In this first embodiment, the base-side case 11 is fixed to the base-bracket 2 as a bracket on a seat cushion side, and the arm-side case 12 is fixed to the arm-bracket 3 as a bracket on a seatback side. However, the base-side case 11 may be fixed to the arm bracket 3, whereas the arm-side case 12 is fixed to the base bracket 2.

### Second Embodiment

All the basic structure of a seat reclining apparatus according to a second embodiment is the same as that of the seat reclining apparatus according to the first embodiment. The same components are given the same reference numerals, and a description thereof is omitted while only different components are described.

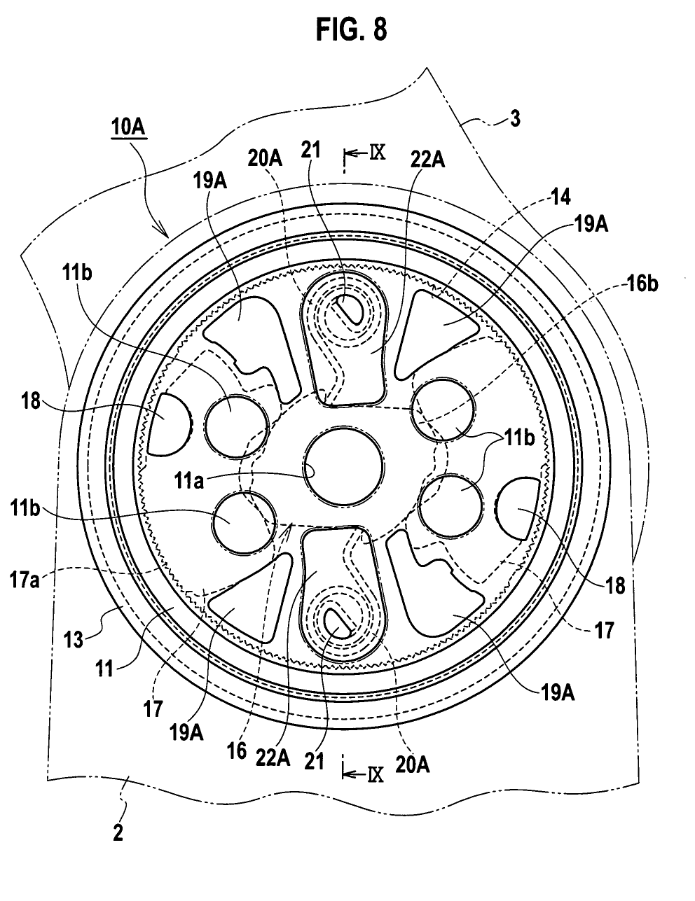

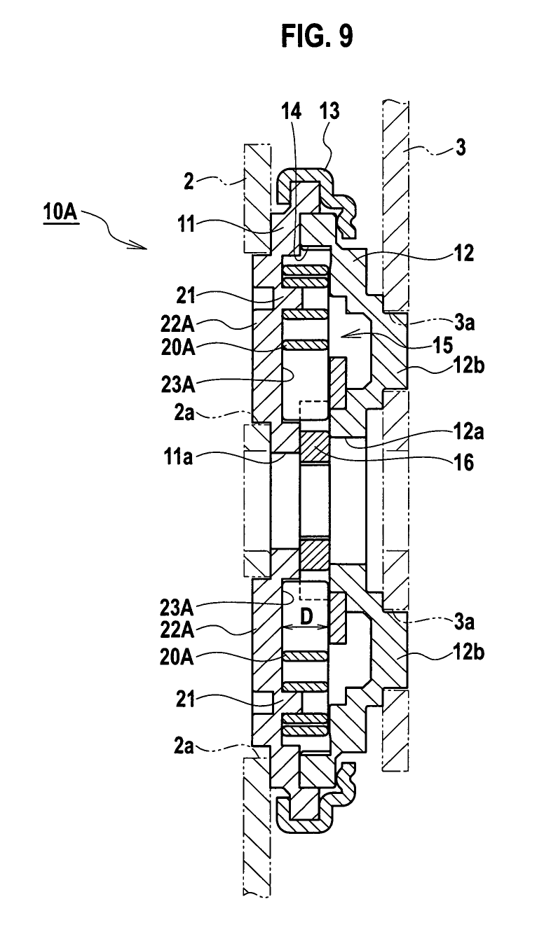

As shown in FIGS. 8 and 9, in a reclining lock mechanism 10A of the seat reclining apparatus according to the second embodiment, lock springs 20A are configured to increase in plate width with the diameter reduced, and protrusions 22A integrally provided for the outer surface of the base-side case 11 are therefore configured to be smaller than those of the first embodiment. Accordingly, on the inner surface of the base-side case 11, recesses 23A smaller than those of the first embodiment are formed at positions corresponding to the protrusions 22A. In other words, the spring accommodation spaces of the component accommodation space 15 are smaller than those of the first embodiment. The component accommodation space 15 accommodates the lock springs 20A which have the same spring force as the conventional seat reclining apparatus but a smaller number of turns. Since the protrusions 22A are smaller, attachment holes 2a of the base bracket 2 are accordingly configured to be smaller.

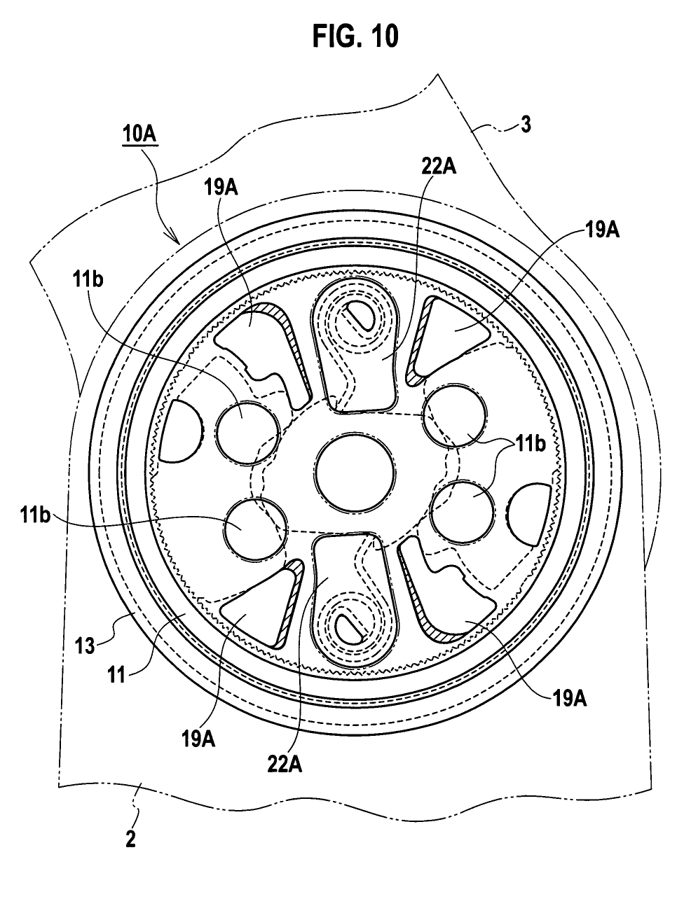

Each lock spring 20A occupies smaller space, so that tooth receiving portions 19A are configured to be larger than those of the first embodiment. In FIG. 10, hatching shows areas by which the receiving portions 19A of the second embodiment are larger than the receiving portions 19 of the first embodiment.

Since the lock springs 20A can secure spring force equal to that of the conventional seat reclining apparatus with a smaller number of turns and a smaller plate thickness, each lock spring 20A can be accommodated in smaller space. The tooth receiving portions 19A can be configured to be larger accordingly, thus increasing the load bearing capacity without an increase in size.

In the second embodiment, the protrusions 22A are smaller than the protrusions 22 of the first embodiment, and the tooth receiving portions 19A are configured to be larger. However, the base-side and arm-side cases 11 and 12 may be reduced in radial size for miniaturization of the reclining lock apparatus.

Although the invention has been described above by reference to certain embodiments of the invention, the invention is not limited to the embodiments described above. Modifications and variations of the embodiments descried above will occur to those skilled in the art, in light of the above teachings. The scope of the invention is defined with reference to the following claims.

What is claimed is:

1. A seat reclining apparatus for a vehicle, comprising:
a disk-shaped base-side case fixed to a first one of a bracket on a seat cushion side and a bracket on a seatback side;
a disk-shaped arm-side case fixed to a second one of the brackets and rotatably assembled to the base-side case, the arm-side case including an inner circumferential tooth portion on a periphery of a circular recess concentrically formed;
a component accommodation space formed between the base-side case and arm-side case;
a center shaft rotatably disposed in center part of the base-side case and center part of the arm-side case, while penetrating the component accommodation space;
a cam member fitted on the center shaft to rotate integrally with the center shaft in the component accommodation space, and moved by the rotation of the center shaft between a locked position and an unlocked position;
a lock tooth unit which is arranged radially outside of the cam member in the component accommodation space and cooperates with the cam member, the lock tooth unit being located at an engaged position where the lock tooth unit is engaged with the inner circumferential tooth portion when the cam member is at the locked position, and being located at a disengaged position where the lock tooth unit is separated from the inner circumferential tooth portion when the cam member is at the unlocked position;
a lock spring which is arranged radially outside of the cam member in the component accommodation space, and urges the cam member toward the locked position;
a protrusion protruding from an outer surface of the base-side case; and
a recess at a position corresponding to the protrusion on an inner surface of the base-side case, wherein
the lock spring is arranged in a space formed by the recess and the component accommodation space.

2. The seat reclining apparatus for a vehicle according to claim 1, wherein
the protrusion is fitted into a hole provided for the first bracket, and fixed by welding the fitted protrusion and an edge of the hole of the first bracket.
